(19) United States
(12) Patent Application Publication
(10) Pub. No.: US 2012/0259567 A1
(43) Pub. Date: Oct. 11, 2012

(54) INTELLIGENT BATTERY PACK

(75) Inventor: Andrew LAPIERRE, Mont-Royal (CA)

(73) Assignee: 9058-5878 QUÉBEC INC. (VIDEO ASSIST), Montreal (CA)

(21) Appl. No.: 13/081,837

(22) Filed: Apr. 7, 2011

(51) Int. Cl. G06F 19/00; H02J 7/00

(52) U.S. Cl. 702/63; 320/137; 320/128

(57) ABSTRACT

The present relates to a battery pack adapted for receiving battery cells, and alternately to a battery pack comprising the battery cells. The present battery pack comprises an energy output, an energy input and a controller. The energy output outputs energy from the at least one battery cell. The energy, input receives energy for recharging the at least one battery cell, and the controller controls. the energy received from the energy input for recharging the at least one battery cell.

### FIELD

The present relates to battery packs, and more particularly to an intelligent battery pack capable of controlling recharging and/or discharging of battery cells.

### BACKGROUND,

Portability and mobility has become an important factor in many industries. Nowadays, various types of equipment function on batteries. New batteries with improved performances are constantly emerging the market, thus creating the possibility to convert devices with higher energy demands, such as power tools and professional video equipment to portable devices functioning on batteries.

Although the performances of new batteries have greatly increased, use of battery-powered tools and professional video equipment still suffers from many drawbacks. First, as one single battery pack often times does not suffice to provide power for several hours of professional use, several battery packs must be carried and recharged ahead of time. Secondly, manufacturers each sell their proprietary battery packs and proprietary chargers. Thus if equipment from various manufacturers is used concurrently, multiple battery packs and chargers must be carried. Thirdly, battery packs are sometimes equipped with a display for visually displaying remaining battery power, but displayed remaining battery power are rarely precise, and often times quite inaccurate. Additionally, battery packs are usually sealed, thus rendering transport in the cabin of commercial aircrafts impossible, due to a limit of battery cells allowed in the cabin, thereby limiting their transportation as a checked baggage.

There is thus a need for an improved battery pack that alleviates current problems with commercially available battery packs.

### SUMMARY

The present relates to battery packs, and more particularly to intelligent battery packs.

In a first aspect, the present relates to a battery pack comprising at least one battery cell, an energy output, an energy input and a controller. The energy output is adapted for outputting energy from the at least one battery cell. The energy input is adapted for receiving energy for recharging the at least one battery cell. The controller controls the energy received from the energy input for recharging of the at least one battery cell.

In another aspect, the present battery pack is adapted for receiving at least one battery cell. The battery pack comprises an energy output for outputting, energy from the at least one battery cell, an energy input for receiving energy for recharging the at least tone battery cell; and a controller for controlling the energy received from the energy input for recharging of the at least one battery cell.

### BRIEF DESCRIPTION OF DRAWINGS

The following Figures are provided for explanatory purposes only.

FIG. 1 is a functional block diagram of the intelligent battery pack.

FIG. 2 is an alternate functional block diagram of the intelligent battery pack.

FIG. 3 is a perspective exploded view of the assembly of one battery cell.

FIG. 4 is a perspective view of the insertion of a battery divider.

FIG. 5 is a perspective view of the assembly of the intelligent battery pack.

FIG. 6 is an upside-down rotation perspective view of the intelligent battery pack of FIG. 6.

FIG. 7 is a side elevation view of soldered battery cells to the PCB board in accordance with one exemplary aspect.

FIG. 8 is a perspective view of the present intelligent battery pack inserted in a first portion of a casing.

### DESCRIPTION

The present description relates to an intelligent battery pack. The term ‘intelligent’ is meant to refer to a battery pack that comprises a controller, microcontroller, processor, or microprocessor and that is capable amongst other things of controlling its recharging when energy is received. Although the term “controller” will be used in the following description, it should be construed to refer to any controlling mechanism, either hardware, software, or combination thereof. The term ‘battery pack’ is meant to alternately refer to an intelligent casing adapted to receive one or several battery(ies) or one or several battery cell(s), or to an intelligent casing including the one or several battery(ies) or battery cell(s).

The present intelligent battery pack may further comprise other electronic components such as for example one or several sensors, a memory, a display, and/or a communication module, and may further be adapted to perform a wide range of functions, as will be described later on.

The following description will alternately refer to the present battery pack as ‘the battery pack’, or ‘the intelligent battery pack’. The present intelligent battery pack 10 may be used with various types of equipments and for various types of applications. For example, the present battery pack may be advantageously used with equipment, which requires substantial amount of energy such as for example professional video equipment, power tools, etc, but could also be used with smaller equipments or equipments requiring less energy such as for example laptops, cell phones, cameras, portable video games, etc. The present battery pack is further particularly interesting in that the ‘intelligence’ for recharging is provided within the battery pack, thus allowing the use of a standard power supply to recharge the battery cell(s) within the battery pack, without having to recourse to a separate charger, or various proprietary power chargers and power supplies.

The present intelligent battery pack may be adapted for receiving one or several battery cells, which may be included within the intelligent battery pack. The term ‘battery cell’ is used to refer to any number of batteries used together, such as for example 2, 3, 4, 5, etc batteries used as one single unit. Any type of rechargeable battery, such as for example: nickel-cadmium, nickel-metal hydride, lithium-ion, lithium-ion polymer, lithium sulfur, thin film, potassium-ion, lifepo4, Clifepo4 etc. may be used in a battery cell.

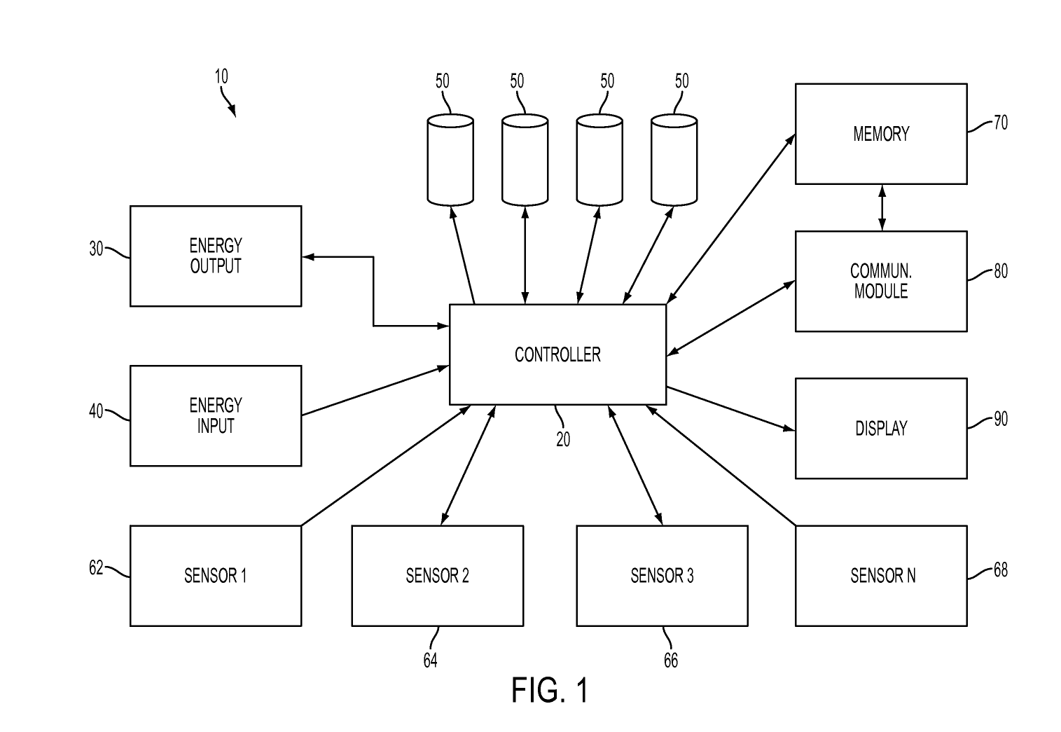

Reference is now made to FIG. 1, which provides a functional block diagram of the present intelligent battery pack 10. In its simplest form, the present intelligent battery pack 10 comprises a controller 20, an energy output 30 and an energy input 40. The controller 20, the energy output 30 and the energy input 40 are included in a casing (not shown), adapted to further receive one or several battery cells 50. The energy input 40 is adapted for receiving energy for recharging the battery cells 50. The energy input 40 may be connected directly to an alternate current (AC) electrical source using a standard power supply. As electrical power varies amongst various countries in voltage, frequency and wall socket used, the energy input 40 requires a power supply and a suitable connector to connect to a wall socket to receive electrical power. The energy output 30 may consist of battery terminals, as known in the art. The controller 20 controls the energy received from the energy input 40 to recharge the battery cells 50. The energy input 40 could consist of direct current, with a voltage in the range of 14 to 30 volts and current of 9 to 20 amps.

In operation, the controller 20 monitors the energy level of the battery cells 50. The battery cells 50 may be used concurrently, in series, or in subgroups, depending on the amount of energy required. When the energy required by the energy output 30 is greater, the controller 20 monitors energy required by the energy output 30, and determines an efficient manner to extract energy of the battery cells 50. Such a determination may take various aspects in consideration. For example, some types of batteries provide better performances when discharged rapidly with a high demand, while other batteries provide performances when discharged slower. Thus, the controller 20 determines an efficient manner to use the energy stored in the battery cells 50 by the energy output 30. Conversely, during recharging of the battery cells 50, the controller 20 controls the electric energy received from the energy input 40, so as to efficiently recharge the battery cells 50. For example, the controller 20 may recharge the battery cells 50 in series, in parallel, in subgroups, etc. The controller 20 may be implemented by means of a microcontroller, an integrated circuit, a Field Programmable Gate Array, or any other known type of electronic device adapted to be programmed either through hard coding or software.

To the intelligent battery pack 10 previously described, many additional components may be added either together or separately: sensor(s), a memory 70, a communication module 80 and a display 90.

One or several sensors 62-68 may be further incorporated to the intelligent battery pack 10 to measure specific conditions of the battery pack. Examples of types of sensors that can be incorporated include temperature sensors, a global positioning sensor, a gyroscope, a tampering detector, an impact sensor, and any type of sensor, which can provide meaningful information for proper and efficient functioning of the intelligent battery pack. For example, in a first aspect, an impact sensor may be incorporated to detect falling of the battery pack. Such information may be particularly interesting when the battery pack is used with rented equipment, so as to track when the battery pack is not properly handled and manipulated. As falling of the battery pack may damage components of the battery pack or affect the battery cells, it becomes even more important for such applications to ensure that any falling of the battery pack 10 is sensed by an impact sensor, for example sensor 61, reported to the controller 20, and stored by the controller 20 in the memory 70 for future use.

Another example of sensor comprises the temperature sensors. Temperature sensors can be used to detect the ambient temperature in which the battery pack 10 is used, and/or the internal temperature of the battery pack 10. As batteries' characteristics vary over temperature, it may be useful to monitor ambient temperature of the battery pack in both discharging and recharging mode. Additionally, it may be useful to monitor the internal temperature of the battery pack 10, so as to determine, when the battery cells 50 may be overheating, and thus modify by the controller 20 how the energy from the battery cells 50 is provided to the energy output 30. In the case of temperature sensors, the temperature may be measured on a regular basis by the controller 20. The controller 20 may then store the measured temperature along with a timestamp comprising for example a date and time for the measured temperature, in the memory 70.

Another type of sensor that may be incorporated to the battery pack is the global positioning system (GPS), as sensor 66. The GPS may regularly or on demand provide a position of the battery pack to the controller 20, which in turn stores the position information in the memory 70 along with a timestamp. The position information may be particularly useful for rental equipment, so as to assess the geographical area in which the rental equipment is used.

Yet another type of sensor that may be incorporated to the battery pack is the ‘gyroscope’ type. A gyroscope may be incorporated as sensor 68. The gyroscope may regularly measure or sporadically measure upon demand from the controller 20, a relative angle of the battery pack with respect to gravity. The relative angle may be representative of how the battery pack is used, stored and manipulated. The information about the relative angle may be stored by the controller 20 in the memory 70 along with a timestamp.

Another type of sensor is an electrical charge sensor. The electrical charge sensor may measure electric charge of the battery cells separately, in sub-groups, or altogether. The electrical charge sensor may regularly, sporadically or on demand measure the electric charge of the battery cells, and report the measured electric charge to the controller 20, which in turn stores the information with a timestamp in the memory 70. By measuring the electric charge of the battery cells and storing the information in the memory 70, it is possible to identify patterns of usage of the battery pack 10, and in turn optimize the controller 20 so as to better meet the needs of user of the battery pack, based on the type and number of battery cells 50 being used.

There is another type of sensor that could also be used in the battery pack: the tampering sensor. The tampering sensor ensures that the battery pack is not opened, or tampered with. Any detection of tampering is reported to the controller 20, which stores, the tampering information in the memory 70 along with a corresponding timestamp.

In addition to the various types of information and conditions detected, the controller 20 may further store in the memory 70 information about the discharging and recharging of the battery pack 10. For example, the controller may store in the memory that the battery pack was recharged during 6 hours, and then unused 12 hours, to be afterwards discharged for 3 consecutive hours with only short breaks of 5 minutes.

The memory 70 may consist of any type of physical device adapted to store data, such as for example integrated circuits, hard disk, memory card, and/or a memory stick.

The battery pack 10 may further comprise a communication module 80. The communication module 80 may directly access the memory 70, or may indirectly access the memory through the controller 20. The communication module 80 may be adapted to perform wire communication or wireless communication. The communication module 80 may communicate with a device such as a computer, a cell phone, a server over the internet, or any other type of device adapted to receive and request information stored in the memory 70 of the battery pack 10 by means of the communication module 80. The communication module 80 may communicate using a standardized protocol such as IPv4, IPv6, WiFi, Bluetooth, RFID, Zigbee, etc. The communication module 80 communicates part or all of the information stored in the memory 70, and may further instruct the controller 20 to erase the information stored in the memory 70. Thus when the battery pack is rented together with equipment, it is possible upon return of the battery pack 10 to download all the information stored in the memory 70 during the rental period, so as to verify that the battery pack 10 was used, stored and, recharged properly.

The communication module 80 may further be used to retrace any battery pack 10 that has not been returned on time. When a rental period has ended and the battery pack has not been returned, the communication module 80 may receive a request from an authorized server, to download the information stored in the memory 70, and may further instruct the controller 20 to collect information by means of the sensors, to also be transferred by means of the communication module 80.

The battery pack 10 may further be equipped with a display 90. The display 90 may be installed on the exterior of the battery pack or visible from the exterior of the battery pack 10. The display 90 is adapted to display a remaining charge of the battery pack 10. The display 90 visually represents the remaining charge either by means of an icon, a percentage of remaining charge, a remaining time of use, or any other suitable means for displaying the remaining charge to a user of the battery pack 10.

The remaining charge of the battery pack 10 is calculated by the controller 20. Various methods of calculations may be used. Examples of the methods of calculations include:
based on a coulomb counter counting coulomb charged and discharged;
based on a pre-defined average use of the battery cell(s);
based on a predefined maximum use of the battery cell(s);
based on a computed average use of the battery cell(s) since a previous recharge;
based on a computed maximum use of the battery cell(s) since a previous recharge;
based on a computed average use of the battery cell(s) in a previous period of time; or
based on a computed maximum use of the battery cell(s) in a previous period of time.

Although the present intelligent battery pack has been described as including the battery cells, the present intelligent battery pack does not necessarily comprise the battery cells when sold. For example, it is possible to manufacture and sell the present intelligent battery pack, and a user or the battery pack may add the battery cells after purchase.

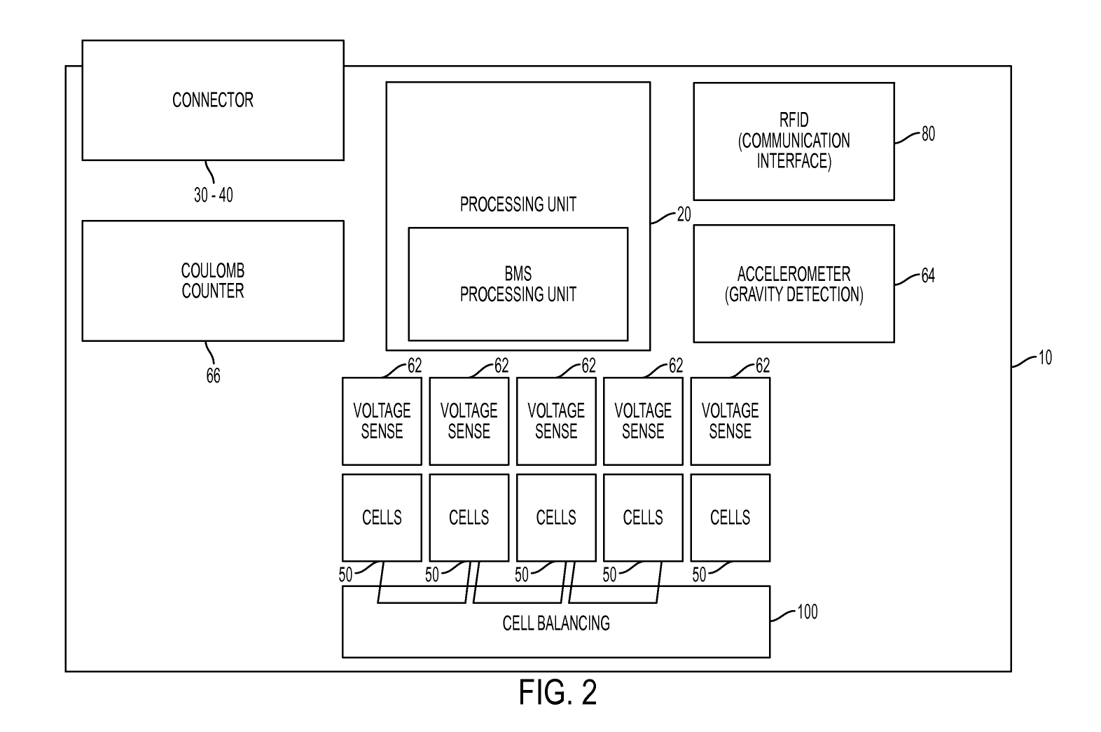

Reference is now made to FIG. 2, which represents an alternate functional block diagram of the present intelligent battery pack. In this embodiment, the controller 20 is a processing unit, which comprises a BMS (batterie management system) processing unit. The energy output and input 30 and 40 are connectors. The intelligent battery pack is further equipped with 4 battery cells 50, each comprising LifePo4 batteries. To each battery cell 50 is assigned a sensor 62, which is more particularly in the present embodiment a voltage sense. The sensors 62 report to the processing unit 20 which together with a cell balancing unit 100, balances the charging and discharging of the battery cells 50. The cell balancing unit 100 may be implemented in hardware, or combination of hardware and software adapted to be run by the processing unit 20. The intelligent battery pack 10 further comprises two more sensors, namely an accelerometer 64 and a Coulomb counter 66. The accelerometer 64 reports any shock applied to the intelligent battery pack 10, while the Coulomb counter 66 is used to calculated a number of Coulomb received during charging, and a number of Coulomb released during discharging. The intelligent battery pack 10 further comprises a communication module 80, Which is an Radio Frequency Identification communication interface.

### Method of Manufacturing and Assembly of the Intelligent Battery Pack

To manufacture and assemble the present intelligent battery pack, various manufacturing and assembly methods may be used. The following describes an example of such an assembly method.

The assembly starts with collecting the required material, i.e. battery cells, one or several PCB boards comprising the components to perform the various functions of the present intelligent battery pack, an LCD display, and a casing. Other components may further be required, such as a multimeter to perform electrical measurements, an assembly jig, casing liners, battery cell dividers, soldering iron and a computer, corresponding software and connectors to program microprocessor(s) or any other programmable component. The computer and corresponding software may further be used to calibrate the intelligent battery pack or components thereof.

The assembly continues with the removal of left crackers on the PCB board(s). In the context of the present intelligent battery pack, one or several PCB boards could be used concurrently, depending on the desired battery cells configuration, size of the casing, price of the PCB boards, etc. Then, an electrical conduction test is performed for every cell connection on the PCB boards. The electrical conduction test may be performed in forward and/or blocking conduction mode. The assembly then continues with programming and calibration of the BMS (batterie management system) and of the microcontroller(s).

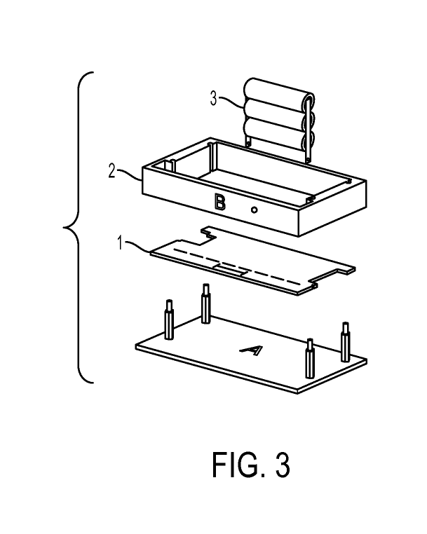

The assembly then proceeds with assembly of the battery cells, as shown on FIG. 3. As previously indicated, various types of batteries may be used in the present intelligent battery pack. In addition, the number of batteries per battery cell, and the number of battery cells within an intelligent battery pack may also vary. Particular examples of numbers of batteries per battery cells and battery cells per intelligent battery pack may comprise the following: 4 battery cells where each battery cell comprises 6 batteries, 4 battery cells where each battery cell comprises 4 batteries, or 5 battery cells where each battery cell comprises 6 batteries. To assemble the battery cells, the assembly jig may be used. The assembly jig may be installed on a flat and solid surface. The PCB board(s) are then installed on the assembly jig. Then, a peripheral support member may be installed around the PCB board(s) to receive and support the battery cells during assembly.

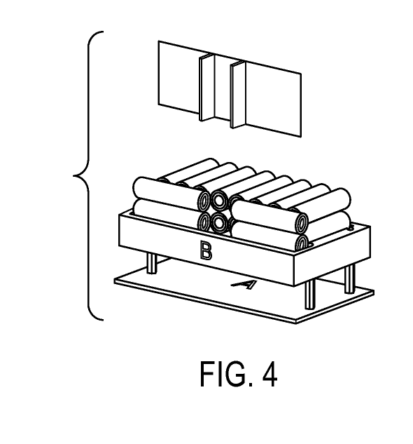

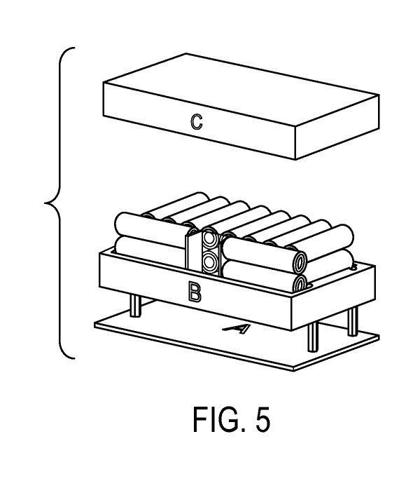

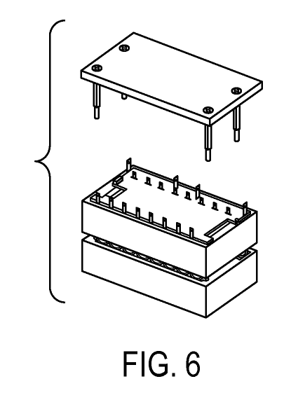

Reference is now made to FIGS. 4, 5 and 6. In FIG. 4, a battery divider is inserted between the battery cells, so as to avoid lateral movements of the battery cells. Additionally, the battery divider may further act as an electrical insulator, so as to avoid undesired electrical contact between contact points of the batteries of the battery cells. Then, as shown on FIG. 5, a temporary cap is installed above and around the battery cells so as to maintain the latter in place for the soldering process. Then, in FIG. 6, the assembly jig, peripheral member and temporary cap are rotated upside-down, so as to allow removal of the assembly, jig, and exposing the connections of the battery cells and the PCB board(s). The battery cells are then soldered to the corresponding connector on the PCB board(s). Soldering the battery cells to the PCB board(s) electrically interconnects the battery cells to the PCB boards), but also mechanically solidifies them together, so that to allow removal of the peripheral support member and temporary cap.

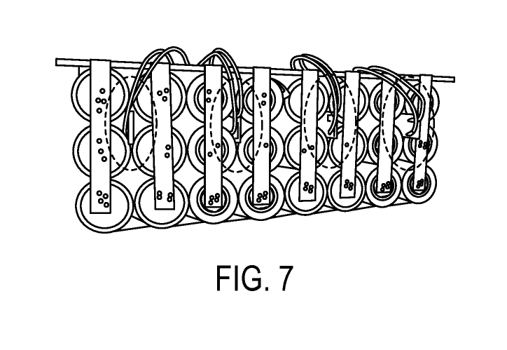

After the battery cells have been soldered to the PCB board(s), the sensor(s) are then soldered to the PCB board(s) in their appropriate position. FIG. 7 is a side elevation view of soldered battery cells to the PCB board in accordance with one exemplary aspect. In FIG. 7, temperature sensors are inserted between each pair of battery cells as shown in the circled areas, but the temperature sensors could be located differently, depending on the information collected.

Then, an LCD display is affixed and its connector is mechanically and electrically connected to the appropriate location on the PCB board(s). The assembly pursues with the preparation of a back cover of the casing, where a main connector is inserted and mechanically secured with a retaining mechanism such as screws. To prevent undesired movement of the components of the intelligent battery pack within its casing, foams, bumpers or any similar device, is/are affixed inside the main casing prior to its insertion therein. Then, the soldered battery cells and PCB board(s) are inserted into the main compartment of the casing.

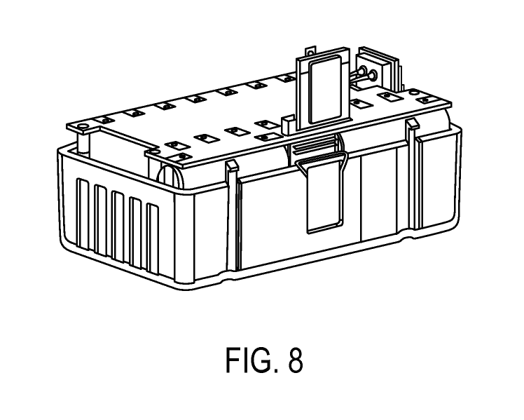

FIG. 8 is a perspective view of the present intelligent battery pack inserted in a main compartment of the casing. FIG. 8 further shows insertion of a plastic window over the LCD display so as to protect the latter. The assembly afterwards continues with steps of verification and activation. When the intelligent battery pack has been successfully verified and activated, the main compartment and the back cover of the casing are closed together and sealed. Additional securing mechanisms such as for example screws may be used to solidify the closure of the casing. An anti-tampering mechanism may further be used to prevent unauthorized opening of the casing.

Although the present intelligent battery pack has been described by way of embodiments, the present intelligent battery pack is not limited to such embodiments. The present description should only be used for clarification purposes, while the scope of protection sought is defined in the attached set of claims.

1. A battery pack comprising:
at least one battery cell;
an energy output for outputting energy from the at least one battery cell;
an energy input for receiving energy for recharging the at least one battery cell; and
a controller for controlling the energy received from the energy input for recharging of the at least one battery cell.

2. The battery pack of claim 1, wherein the at least one battery cell is composed of lifePo4 or ClifePo4 batteries.

3. The battery pack of claim 1, wherein the controller further controls discharging of the at least one battery cell.

4. The battery pack of claim 1, further comprising:
at least one sensor for detecting at least one condition of the battery pack; and
a memory for storing the detected at least one condition.

5. The battery pack of claim 4, wherein one of the at least one sensor detects at least one condition of at least one of the battery cell.

6. The battery pack of claim 4, wherein the memory is further adapted for storing discharging and recharging information.

7. The battery pack of claim 1, further comprising a display, and wherein the controller calculates a remaining charge of the at least one battery cell and visually represents the remaining charge on the display.

8. The battery pack of claim 7, wherein the remaining charge is calculated in one of the following manners:
based on a coulomb counter;
based on a pre-defined average use of the at least one battery cell;
based on a predefined maximum use of the at least one battery cell;
based on a computed average use of the at least one battery cell since a previous recharge;
based on a computed average of the impedance in the cell,
based on a computed maximum use of the at least one battery cell since a previous recharge;
based on a computed average use of the at least one battery cell in a previous period of time; or
based on a computed maximum use of the at least one battery cell in a previous period of time.

9. The battery pack of claim 6, further comprising a communication module for communicating information stored in the memory.

10. The battery pack of claim 9, wherein the communication module communicates wirelessly and/or in a wired configuration.

11. A battery pack for receiving at least one battery cell, the battery, pack comprising:
an energy output for outputting energy from the at least one battery cell;
an energy input for receiving energy for recharging the at least one battery cell; and
a controller for controlling the energy received from the energy input for recharging of the at least one battery cell.

12. The battery pack of claim 11, wherein the controller further controls discharging of the at least one battery cell.

13. The battery pack of claim 11, further comprising:
at least one sensor for detecting at least one condition of the battery pack; and
a memory for storing the detected at least one condition.

14. The battery pack of claim 13, wherein one of the at least one sensor detects at least one condition of at least one of the battery cell.

15. The battery pack of claim 13, wherein the memory is further adapted for storing discharging and recharging information.

16. The battery pack of claim 11 further comprising a display, and wherein the controller calculates a remaining charge of the at least one battery cell and visually represents the remaining charge on the display.

17. The battery pack of claim 16, wherein the remaining charge is calculated in one of the following manners:
based on a coulomb counter;
based on a predefined average use of the at least one battery cell;
based on a predefined maximum use of the at least one battery cell;
based on a computed average use of the at least one battery cell since a previous recharge;
based on a computed maximum use of the at least one battery cell since a previous recharge;
based on a computed average use of the at least one battery cell in a previous period of time; or
based on a computed maximum use of the at least one battery cell in a previous period of time.

18. The battery pack of claim 15, further comprising a communication module for communicating information stored in memory.

19. The battery pack of claim 18, wherein the communication module communicates wirelessly and/or in a wired configuration.
